(19) United States
(12) Patent Application Publication
(10) Pub. No.: US 2014/0358287 A1
(43) Pub. Date: Dec. 4, 2014

(54) REFRIGERATOR AND METHOD FOR CONTROLLING THE SAME

(71) Applicant: SAMSUNG ELECTRONICS CO., LTD., Suwon-si (KR)

(72) Inventors: Eun Jung LEE, Seoul (KR); Kyung Woo Ko, Seoul (KR); You Na Park, Seoul (KR)

(73) Assignee: SAMSUNG ELECTRONICS CO., LTD., Suwon-si (KR)

(21) Appl. No.: 14/287,485

(22) Filed: May 27, 2014

(30) Foreign Application Priority Data
May 28, 2013 (KR) 10-2013-0060143

(51) Int. Cl. G05B 13/02

(52) U.S. Cl. CPC G05B 13/02
USPC 700/275

(57) ABSTRACT

A refrigerator includes a communication unit to receive a list of food purchased by a user from a food server; a control unit to read information with respect to food on the received list of food, and identify a representative image that represents the food based on the read information; a display unit to display the received list of food such that the food on the list of food is displayed as the representative image that represents the food; and a storage unit to store the read information. Accordingly, a design effect is enhanced by expressing the information of the purchased food as a representative image and by displaying additional information of the representative image. In addition, the information with respect to the purchased food is easily stored at a refrigerator, and the information with respect to new products is easily and quickly obtained, thus a user convenience is enhanced.

### CROSS-REFERENCE TO RELATED APPLICATIONS

This application claims the priority benefit of the Korean Patent Application No. 10-2013-0060143, filed on May 28, 2013, in the Korean Intellectual Property Office, the disclosure of which is incorporated herein by reference.

### BACKGROUND

1. Field

Embodiments of the present disclosure relate to a refrigerator to output information with respect to food, and a control method thereof.

2. Description of the Related Art

A refrigerator is an apparatus to store goods such as food and beverages for a long period of time in a fresh status.

The refrigerator is provided with a plurality of storage compartments, and the plurality of storage compartments include a refrigerating compartment to store goods in a refrigerated manner, and a freezing compartment to store goods in a frozen manner, and the refrigerator is to maintain the internal temperature of each of the refrigerating compartment and the freezing compartment at a predetermined target temperature by repeatedly performing a refrigeration cycle including compression-condensation-expansion-evaporation.

The food stored in the refrigerator is used at the time of when a user desires to do so by withdrawing the food. After the user identifies what type of food is present at an inside the refrigerator, the food needed or the food with short supply is purchased again. Then the user checks each food stored to identify the storage period.

With respect to the refrigerator as the above, the stored food in the refrigerator is difficult to be identified in a precise manner, and thus a user is needed to identify each food stored, and the circulation period of each food stored is also needed to be checked.

In recent years, the internal temperature of a refrigerating compartment or a freezing compartment is provided to be identified by a user through a display provided at the refrigerator, and in addition, when information such as the quantity or the type of the food stored in the refrigerator is input, the information as such is displayed, so that a user may be aware of the quantity or the type of the food stored in the refrigerator.

However, as the function to set up a storage period of stored goods is not provided on the display, a user still may not easily be able to determine the time when the stored goods are stored or the storage period of the stored goods.

### SUMMARY

Therefore, it is an aspect of the present disclosure to provide a refrigerator to express information of purchased food as a representative image and display additional information on the representative image, and a control method thereof.

It is another aspect of the present disclosure to provide a refrigerator to be supplied with information of purchased food and information of new products through a communication, store the supplied information, display the stored information, and guide the optimal place of storage, the optimal storage temperature, and the optimal time of consumption on the basis of the information of the purchased food, and a control method thereof.

It is still another aspect of the present disclosure to provide a refrigerator to display the storage period, the storage temperature, the storage place, the optimal time of consumption, and the storage status of food stored in the refrigerator, generate a consumption schedule based on at least one of the storage period, the circulation period, the optimal time of consumption, the storage status, and the expiration of the food, and display information of recipe, and a control method thereof.

Additional aspects of the disclosure will be set forth in part in the description which follows and, in part, will be obvious from the description, or may be learned by practice of the disclosure.

In accordance with an aspect of the present disclosure, a refrigerator includes a communication unit, a control unit, a display unit and a storage unit. The communication unit may be to receive a list of food purchased by a user by communicating with a food server. The control unit may be to read information with respect to food on the received list of food, and identify a representative image that represents the food based on the read information with respect to the food. The display unit may be to display the received list of food such that the food on the list of food is displayed as the representative image that represents the food. The storage unit may be to store the read information with respect to the food.

The display unit may display additional information of the food on the representative image in an overlapping manner.

The additional information may include at least one of a period of storage, a storage temperature, a storage place, an expiration date, and an optimal time of consumption.

The control unit may identify an expiration date of food that is stored in the storage unit, and generates a consumption schedule based on the identified expiration date of the food. The display unit displays the generated consumption schedule.

The refrigerator may further include a detection unit to detect a storage status of food stored in a storage compartment. The control unit may generate the consumption schedule based on at least one of the expiration date, the optimal time of consumption, and the storage status of the stored food. The display unit may display the generated consumption schedule.

The display unit may include a plurality of alarm windows each having different color information to notify a priority of the consumption in stages. The information with respect to the food may be displayed on the plurality of alarm windows in an overlapped manner, based on the priority of the consumption.

The control unit may generate the consumption schedule based on the storage status of the food. The display unit may display the generated consumption schedule.

The refrigerator may further include a detection unit to detect a storage status of food stored in the storage compartment. The control unit may generate the consumption schedule based on the storage status of the stored food. The display unit may display the generated consumption schedule.

The communication unit may receive weather information from a weather server. The control unit may suggest a cooking list based on the received weather information and the consumption schedule.

The communication unit may receive information with respect to a new product from the food server. The control unit may identify a representative image that represents the received information with respect to the new product, and identifies an icon that corresponds to the new product. The display unit may display the identified icon of the new product on the identified representative image of the new product in an overlapping manner.

The refrigerator may further include an input unit to receive the information with respect to the food purchased by the user, and enable at least one food to be selected on the received list of food.

The input unit may receive a command to delete information with respect to withdrawn food. The storage unit may delete the information with respect to the food, which is commanded to be deleted, in the stored information of the food.

The control unit may identify food that is needed, identify a representative image of the needed food, and identify a purchase indication icon indicating that there is a food needed. The display unit may display the purchase indication icon on the identified representative image of the needed food in an overlapping manner.

In accordance with another aspect of the present disclosure, a refrigerator includes a communication unit, a control unit, a user interface unit, a user interface unit and a storage unit. The communication unit may receive a list of food purchased by a user by communicating with a food server. The control unit may read information with respect to food on the received list of food, and generate a consumption schedule based on information of date of the read information with respect to food. The user interface unit may display the received list of food, and display the generated consumption schedule. The storage unit may store the read information with respect to food and the consumption schedule.

The user interface unit may display the list of food and the consumption schedule on different domains, respectively.

The user interface unit, when the information with respect to of the food on the list of food is dragged onto the consumption schedule, may additionally displays the information with respect to the food on the consumption schedule.

The information of the date of the food may include at least one of a storage period, an expiration date, and an optimal time of consumption.

The refrigerator may further include a detection unit to detect a storage status of food stored in a storage compartment. The control unit may generate the consumption schedule based on the storage status.

The control unit may generate a cooking list based on the generated consumption schedule, and the user interface unit may display the cooking list.

The control unit may identify a recipe for at least one dish on the cooking list, and the user interface unit may display the recipe when a command to identify the recipe for the at least one dish.

The control unit may identify food that is needed, based on the recipe. The user interface unit may display the identified food when the recipe is selected.

The communication unit may receive weather information from the weather server. The control unit may generate the consumption schedule based on the received weather information.

The communication unit may receive information with respect to a new product. The user interface unit may display the information with respect to the new product when the new product is selected.

In accordance with another aspect of the present disclosure, a method of controlling a refrigerator include receiving information with respect to food that is purchased by a user, reading and storing information with respect to food on a received list of food, identifying a representative image that represents the purchased food, based on the read information with respect to the food, displaying the food on the list of food as the representative image, and storing the read information with respect to the food.

The receiving of the information with respect to the food purchased by the user may include receiving a list of food purchased by the user, by communicating with at least one of a food server and a mobile terminal.

The receiving of the information with respect to the food purchased by the user may include receiving the information with respect to the food purchased by the user, through a user interface unit.

The method may further include displaying at least one of a storage period, a storage temperature, a storage space, an expiration date, and an optimal time of consumption on the representative image in an overlapping manner as additional information.

The method may further include identifying at least one information of date of food among a storage period, an expiration date, and an optimal time of consumption of food that are stored in a storage unit; generating a consumption schedule based on the identified information of date of food; and displaying the generated consumption schedule.

The generating of the consumption schedule may include detecting a storage status of food stored in a storage compartment, and generating the consumption schedule based on the storage status.

The method may further include receiving weather information from a weather server, generating a cooking list based on the received weather information and the consumption schedule, and displaying an identified cooking list.

The method may further include identifying a recipe with respect to at least one dish from the cooking list, and displaying the recipe when a command to identify the recipe is input.

The method may further include receiving information with respect to a new product from a food server, identifying a representative image that represents the received information of the new product, identifying an icon that indicates the new product, and displaying the identified icon on the identified representative image in an overlapping manner.

The method may further include receiving a command to delete information with respect to food that is withdrawn, and deleting, by the storage unit, the information of the food that is commanded to be deleted among the information of the food that is stored in the storage unit.

The method may further include identifying food that is needed, identifying a representative image with respect to the food that is identified as needed, identifying a purchase indication icon indicating there is a food that is needed, and displaying the identified purchase indication icon on the identified representative image in an overlapping manner.

In accordance with one aspect of the present disclosure, by expressing the information of the purchased food as a representative image and by displaying additional information on the representative image, a design effect may be enhanced.

In addition, the information with respect to the purchased food may be easily stored and the information with respect to new products may be easily and quickly obtained, and without identifying the food at an inside a refrigerator by opening a door of the refrigerator, the information of the stored food may be identified, and thus a user convenience may be enhanced.

In addition, by generating a consumption schedule on the basis of at least one of the storage period, the optimal time of consumption, the expiration period, and the storage status and by providing cooking information on the basis of the consumption schedule, the recipe information according to the cooking information may be displayed to be provided to a user, so that the usefulness of the refrigerator by a user is enhanced while the waste of food may be reduced.

### BRIEF DESCRIPTION OF THE DRAWINGS

These and/or other aspects of the disclosure will become apparent and more readily appreciated from the following description of embodiments, taken in conjunction with the accompanying drawings of which:

FIG. 1 is a drawing of an example of an inside a refrigerator in accordance with an embodiment of the present disclosure.

FIG. 2 is drawing of an example of a front portion of the refrigerator in accordance with an embodiment of the present disclosure.

FIG. 3 is a control block diagram of the refrigerator in accordance with an embodiment of the present disclosure.

FIG. 4 is a control flowchart of the refrigerator in accordance with an embodiment of the present disclosure.

FIGS. 5 to 10 are drawings of examples of a display of a user interface unit provided at the refrigerator in accordance with an embodiment of the present disclosure.

### DETAILED DESCRIPTION

Reference will now be made in detail to embodiments of the present disclosure, examples of which are illustrated in the accompanying drawings, wherein like reference numerals refer to like components throughout.

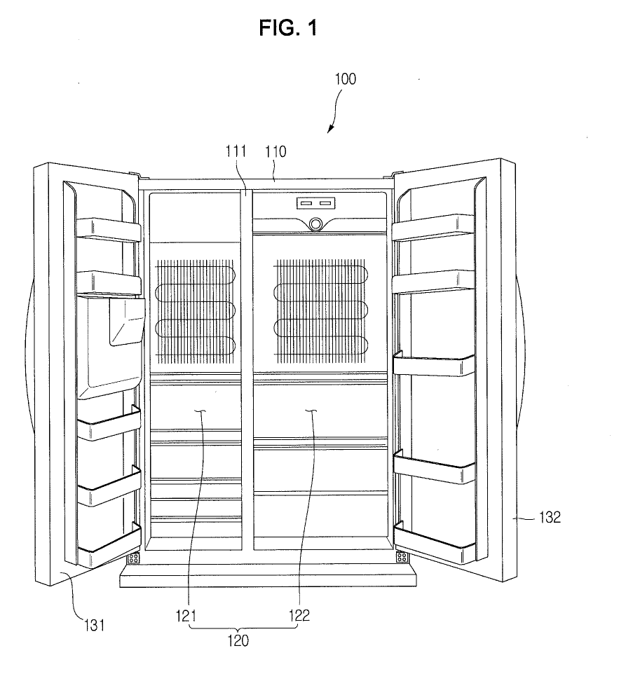

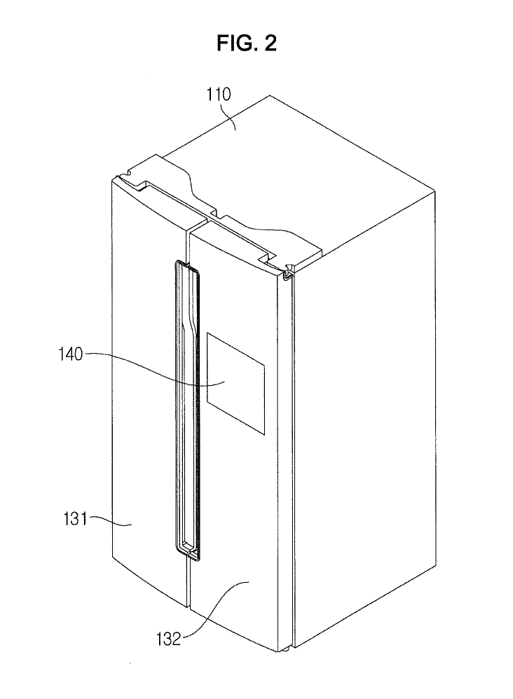

FIG. 1 is a drawing of an example of an inside a refrigerator in accordance with an embodiment of the present disclosure, and FIG. 2 is drawing of an example of a front portion of the refrigerator in accordance with an embodiment of the present disclosure.

As illustrated on FIG. 1, a refrigerator 100 includes a body 110, storage compartments (120: 121 and 122), and doors 131 and 132.

The body 110 forms an exterior appearance of the refrigerator 100.

The refrigerator 100 is provided with an accommodating space formed by the body 110.

In the accommodating space as such, a partition wall 111 is provided, and by the partition wall 111 as such, the accommodating space is divided into left and right. As the above, the accommodating space divided into left and right at the body 110 forms a plurality of storage compartments (120: 121 and 122) to store food. The partition wall 111 is provided vertically to divide the accommodating space into left and right, however, the partition wall 111 may be provided horizontally to divide the accommodating space into top and bottom.

Here, the storage compartment 120 includes a freezing compartment 121, which is referred to as a first storage compartment to store food in a frozen manner, and a refrigerating compartment 122, which is referred to as a second storage compartment to store food in a refrigerated manner.

In addition, at an inside the freezing compartment 121, an ice making compartment (not shown) to make ice may be provided.

A surface of an inside wall of the body 110 to form the freezing compartment 121 is provided with a plurality of holes formed thereto, and the holes as such are referred to as holes to introduce cool air generated at a cool air generating compartment into the freezing compartment 121 and to discharge the cool air of the freezing compartment 121 into the cool air generating compartment.

At the freezing compartment 121, at least one shelf to store food may be mounted.

A surface of an inside wall of the body 110 to form the refrigerating compartment 122 is provided with a plurality of holes formed thereto, and the holes as such are referred to as holes to introduce cool air generated at the cool air generating compartment into the refrigerating compartment 122 and to discharge the cool air of the refrigerating compartment 122 into the cool air generating compartment.

At the inside of the refrigerating compartment 122, shelves and storage boxes to store food are mounted.

The refrigerator 100 includes doors 131 and 132 to open/close an opening of the body 110.

The freezing compartment 121 and the refrigerating compartment 122, each referred to as the plurality of storage compartments, is provided with a front surface thereof open, and at the portion of the open front surface of the freezing compartment 121 and the refrigerating compartment 122, doors 131 and 132 are rotatably mounted.

The doors 131 and 132 as such are to shut off the freezing compartment 121 and the refrigerating compartment 122 from an outside. At an inside of each of the doors 131, and 132, a plurality of door shelves to store food are mounted.

The refrigerator 100 further includes a refrigeration cycle unit (not shown) formed in a space between inner walls of the body 110.

An evaporator of the refrigeration cycle unit is disposed at a rear surface of the storage compartment, and as refrigerant decompressed at a capillary tube is supplied, the surrounding air is cooled by the cooling effect to absorb latent heat of the surrounding, and then the refrigerant in the state of gas is again supplied to a compressor.

The refrigerator 100 further includes a first fan installed to correspond to the evaporator to allow air of the freezing compartment 121 and the refrigerating compartment 122 to be suctioned, and allow a blowing force to be applied to the cool air so that air passed through the evaporator is discharged to the each of the freezing compartment 121 and the refrigerating compartment 122.

The compressor, the condenser, and the capillary tube of the refrigeration cycle unit are disposed at a machinery compartment.

At the machinery compartment, the compressor to compress refrigerant and discharge the compressed refrigerant in the state of high temperature and high pressure, the condenser to condense the compressed high temperature and high pressure refrigerant through heat radiation, the capillary tube to decompress the condensed refrigerant, and a second fan to cool the condenser.

Here, the capillary tube is to supply the decompressed refrigerant to the evaporator while connected to the evaporator. In addition, in place of the capillary tube, an expansion valve may also be used.

Alternatively, the freezing compartment may be positioned at a lower end of the body, and the refrigerating compartment may be positioned at an upper end of the body.

As illustrated on FIG. 2, the refrigerator 100 further includes a user interface unit 140 provided at one of the doors 131 and 132.

Here, the user interface unit 140 is to receive operating information of the refrigerator, and display the operating information of the refrigerator and information of food that is stored at the storage compartments.

The user interface unit 140 as such includes an input unit 141 to receive operating information from a user, and a display unit 142 to display the operating information of the refrigerator and the information of the food stored at the storage compartments.

The user interface unit 140 is to display a design element in an emphasized manner when displaying the information of the food stored in the storage compartments.

In addition, the user interface unit 140 is to enhance the usefulness and the convenience of the refrigerator by displaying a food consumption schedule, cooking information, and recipe.

The user interface unit 140 as such may be implemented in the form of a touch screen.

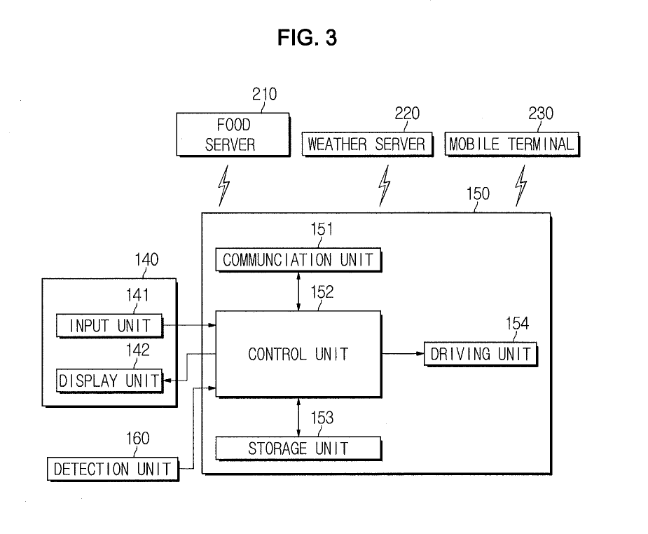

FIG. 3 is a control block diagram of the refrigerator in accordance with an embodiment of the present disclosure.

As illustrated on FIG. 3, the refrigerator includes the user interface unit 140, a driving module 150, and a detection unit 160.

The input unit 141 of the user interface unit 140 receives the information of the food from a user, and receives a selection on at least one of information of food transmitted from a food server 210.

The input unit 141 of the user interface unit is to receive a selection on dish or recipe related to the information of the food, for example.

The input unit 141 of the user interface may receive information by way of dragging or clicking.

In addition, the input unit 141 receives a first target temperature of the freezing compartment and a second target temperature of the refrigerating compartment from a user, and also receives an input of a particular function such as rapid freezing, and transmits the input information to a control unit 152.

The display unit 142 may display variety of information about food stored or to be stored in the storage compartments. For example, the display unit 142 may display the information that there is no consumable food in the storage compartments, display a list of food to be purchased transmitted from a food server or a mobile terminal, and display information of food stored in the storage compartments, a consumption schedule of the stored food, a cooking list of the stored food, a recipe of the stored food, and the alarm.

The display unit 142 may also display lists such as the consumption schedule, the cooking list, the recipe, and the alarm, on a separate domain from a domain displaying the information of the food stored in the storage compartments.

The display unit 142 is to display a representative image of each food, and display additional information on the representative image in an overlapping manner. For example, in a case when beef tenderloin is purchased, the image of a cow is displayed on the display unit such that a portion corresponding to the tenderloin is displayed with a different color to be distinguished from other portions.

The display unit 142 is to display a representative image for each food, and display a purchase icon on the representative image in an overlapping manner. For example, in a case when pork meat is desired, the image of a pig is displayed on the display unit, and on the image of the pig, a text “Buy Now” is displayed in an overlapping manner.

In addition, the display unit 142 displays text information that is related to the consumption of the food on the representative image of each food, in an overlapping manner.

The display unit 142 is to distinguish the food in the order and importance of the food to be consumed first, and display each distinguished food on a plurality of alarm units each having different colors in an overlapping manner.

The display unit 142 is to display the first target temperature and the second target temperature, a detected temperature of the refrigerating compartment, and a detected temperature of the freezing compartment, and also display a particular function selected by a user.

The driving module 150 is to drive each load on the basis of the data transmitted from the user interface unit 140 and the detection unit 160, and includes a communication unit 151, the control unit 152, a storage unit 153, and a driving unit 154.

The communication unit 151 is capable of performing a communication in a wireless or wired scheme, and is to perform a communication with at least one of the food server 210, a weather server 220, and the mobile terminal 230.

The communication unit 151 as such is to receive information with respect to the food, which is purchased by a user, from the food server 210, receive the weather information from the weather server 220, receive at least one of the information with respect to the food purchased by a user and the weather information from the mobile terminal 230, and transmit the received information to the control unit 152.

The control unit 152, when the information with respect to the food purchased by a user is transmitted from the food server 210 or the mobile terminal 230, controls the display unit 142 displays that the information is being loaded, and controls the displaying and the storing of the information with respect to the food purchased.

The control unit 152, when the information with respect to the food purchased by a user is directly input through the input unit 141, controls the displaying and the storing of the information with respect to the food purchased.

The control unit 152 determines whether any food is present for a user to consume, on the basis of information of food stored in the storage unit 153, and if determined that no consumable food for the user is present, controls the display unit 142 to display a text to notify that no disposable food is present.

The control unit 152 identifies information of food that needs to be purchased, on the basis of the information of the food stored in the storage unit 152, the consumption schedule, and the dish selected by a user, and controls the display unit 142 to display the identified information of the food.

The control unit 152 identifies a representative image for each food purchased, and displays the purchased food the representative image. In this case, the control unit 142 controls the display unit 142 to display additional information of the food on the representative image in an overlapping manner.

Here, the additional information is referred to as at least one information of a storage period, a storage temperature, a storage place, an expiration date, and an optimal time of consumption, for example. The additional information may be any information regarding the food, the food purchase, the storage of the food.

The control unit 152 identifies at least one date information of food among the storage period, the expiration date, and the optimal time of consumption of the food stored in the storage unit, generates a consumption schedule on the basis of the identified information of the date of the food, and controls the display unit 142 to display the generated consumption schedule.

The control unit 152 generates the consumption schedule on the basis of a storage status of food that is detected from the detection unit 160, and controls the display unit 142 to display the generated consumption schedule.

The control unit 152, on the basis of the storage status of the food, determines food that has the expiration date thereof approached, determines the priority on the consumption of the determined food, and displays the priority on the consumption of the food in stages. In this case, the control unit 152 controls the display unit 142 to display the information of the corresponding food on the alarm windows each having a different color according to the order of priority on the consumption of the food in an overlapping manner.

The control unit 152, upon receipt of weather information from the weather server, generates a cooking list on the basis of the received weather information and the consumption schedule, and controls the display unit 142 to display the generated cooking list.

The control unit 152 identifies a recipe with respect to the dish selected by a user from the cooking list, and controls the display unit 142 to display the identified recipe.

The control unit 152, upon receipt of information with respect to a new product from the food server, identifies a representative image that represents the received new product, and controls the display unit 142 to display a new product icon on the identified representative image in an overlapping manner.

The control unit 152, upon input of a command to delete information with respect to withdrawn food, updates the information of the food stored in the storage unit.

In addition, the control unit 152 controls the driving of the compressor, the first fan, and the second fan on the basis of the first target temperature and the second target temperature that are transmitted from the input unit 141, as well as the first detected temperature and the second detected temperature that are detected from the detection unit.

The storage unit 153 stores the representative image by each food, and stores the storage period, the storage temperature, the storage place, the expiration date, and the optimal time of consumption by use of the information of the food.

The storage unit 153 stores icons, which are referred to as respective pieces of indication information that correspond to new products, and icons, which are referred to as respective pieces of indication information that correspond to the food needed.

The storage unit 153 stores the type of dish that may be prepared by using at least one food, and information of a recipe for each dish.

The storage unit 153 stores the first target temperature and the second target temperature that are transmitted from the input unit 141, and stores a first predetermined time and a second predetermined time.

Here, the first target temperature is lower than the second target temperature, and the first predetermined time and the second predetermined time are same or different with respect to each other.

The driving unit 154 drives various loads provided at the refrigerator on the basis of commands of the control unit 152.

In more detail, the driving unit 154 includes a compressor driving unit to drive the compressor, a fan driving unit to drive the first fan and the second fan, and a valve driving unit to drive the expansion valve.

The detection unit 160 detects the phase change or the color change of food. The detection unit 160 as such includes an image sensor and a gas sensor.

The detection unit 160 further includes a temperature detecting unit to detect the temperature of the storage compartments.

Here, the temperature detecting unit includes a first temperature detecting unit provided at the freezing compartment 121 to detect the temperature of the freezing compartment 121, and a second temperature detecting unit provided at the refrigerating compartment 122 to detect the temperature of the refrigerating compartment 122.

The detection unit 160 transmits the first detected temperature of the freezing compartment 121 detected by the first temperature detecting unit and the second detected temperature of the refrigerating compartment 122 detected by the second temperature detecting unit to the control unit 152.

In addition, the food server 210 transmits the information of the food, which is purchased by a user, on the basis of membership information and credit card information, to the refrigerator of the user.

The weather server 220 transmits weather information to the refrigerator of a user.

The mobile terminal 230 is referred to as a terminal capable of being transported, such as a notebook computer, a PC, and a mobile phone, and when the information of the food purchased is input by a user, transmits the information that is input to the refrigerator.

The mobile terminal as such may include a food shopping list application.

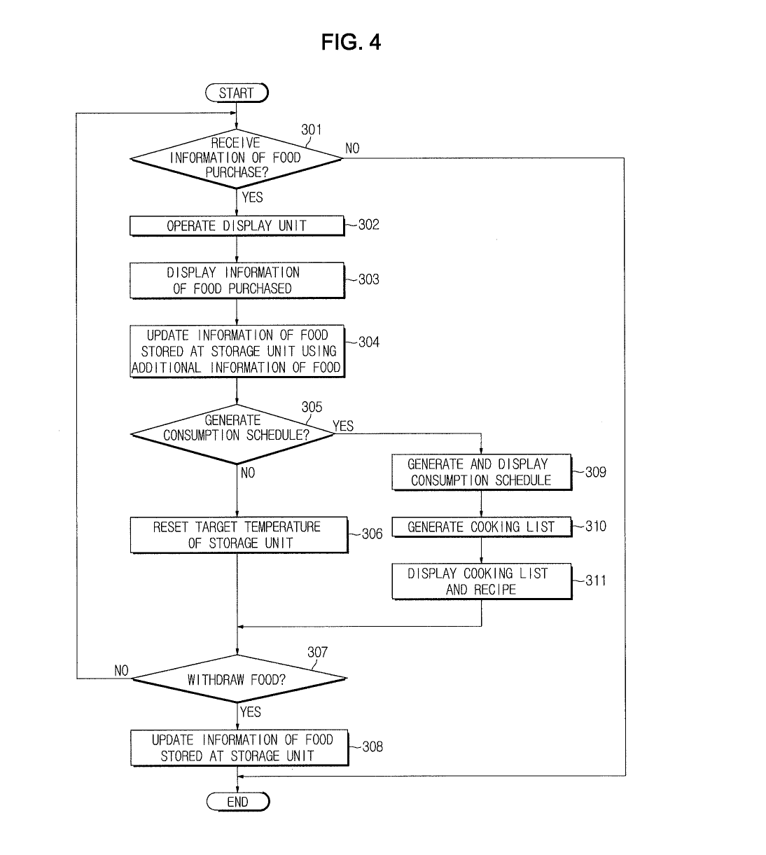

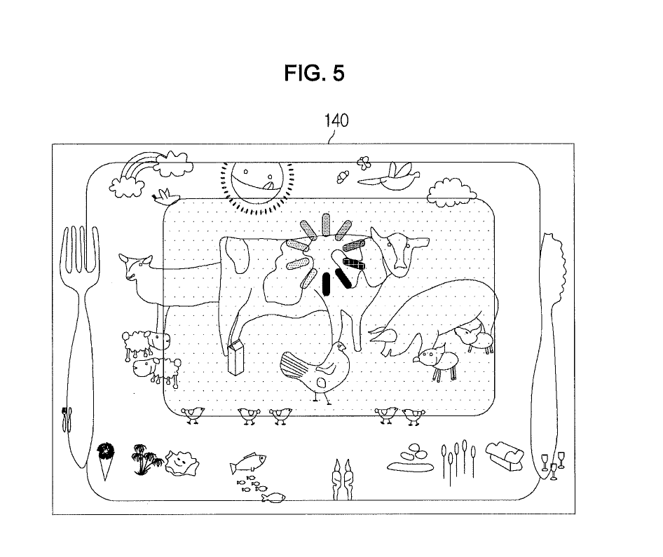

FIG. 4 is a control flow diagram of the refrigerator in accordance with an embodiment of the present disclosure, and will be described by referring to FIGS. 5 to 10.

First, as a power is applied from an outside commercial power source, the refrigerator drives the compressor while selectively rotating the first fan and the second fan to cool the freezing compartment, which is referred to as the first storage compartment, and the refrigerating compartment, which is referred to as the second storage compartment, thereby maintaining the freshness of the stored food inside the refrigerator.

The display unit of the refrigerator, upon receipt of the information of the food from the food server 210 or the mobile terminal 230 (301) while maintaining a standby status, performs an operation of displaying a loading screen (302).

As illustrated on FIG. 5, the display unit of the refrigerator displays a design image as a default mode while displaying a loading screen on the design image. Here, the design image may includes representative images of food to be stored in the refrigerator.

The refrigerator may be able to receive the information of food from a user.

In addition, the refrigerator may display a representative image with respect to the food stored in the storage compartment, and also display a loading screen on the representative image in an overlapping manner.

Next, the refrigerator, when the loading is complete, adds food purchased by a user to the already stored food on a list of food, and displays the list (303). Alternatively, displaying only the list of the food purchased by the user may be possible.

At this time, the refrigerator identifies the representative image of each food, and displays the identified representative image. In addition, the refrigerator may display additional information of the representative image on the representative image in an overlapping manner.

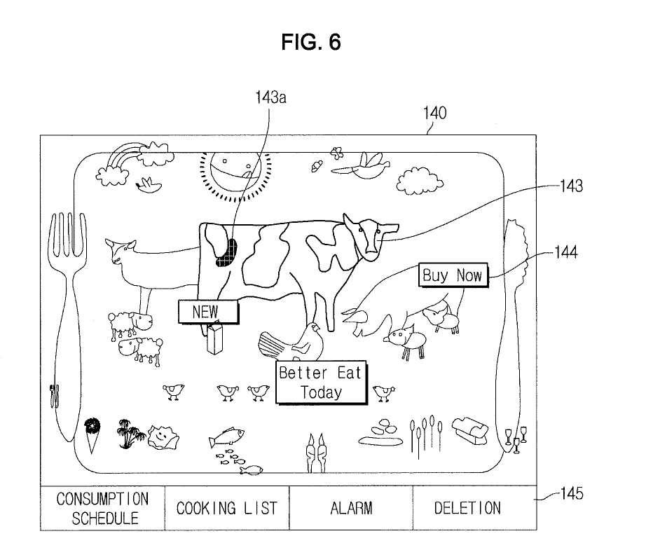

As illustrated on FIG. 6, the refrigerator identifies the representative image of the each food purchased, and displaying the purchased food as the representative image 143, such that additional information of the food is displayed on the representative image in an overlapping manner.

For example, in a case when beef is purchased, the image of a cow is displayed on the display unit. At this time, the display unit may display a portion corresponding to the beef with a different color to be distinguished from other portions.

The refrigerator displays the list of the food stored in the storage unit on a certain domain of the display unit while displays a menu bar 145 related to the food on the remaining domain.

Here, the menu bar 145 related to the food includes a consumption schedule, a deletion, an alarm, and a cooking list.

Here, the consumption schedule is to display the respective pieces of food that need to be consumed according to days and dates, and the cooking list is referred to as a list of the dish that may be prepared by using the food included in the consumption schedule.

The deletion is to, when food is withdrawn by a user from the inside of the storage compartment, select and delete the withdrawn food.

The alarm is to distinguish the food by use of different colors to identify which food is needed to be consumed first according to the order of importance in the consumption of the food while considering the hygienic and the decomposition status of the food.

Then, the refrigerator stores only the food, which is selected by a user from the list of the food displayed, in the storage unit.

At this time, in the storage unit, the information of the food already stored is stored together with the information of the selected food, and the storage unit performs update of the information (304). Alternatively, the refrigerator may be able to store the information of all the food purchased by a user.

The refrigerator stores a name of the food together with at least one information of the storage period, the storage temperature, the storage place, the expiration date, and the optimal time of consumption, which are referred to as additional information of the food.

Next, the refrigerator determines if the generating of the consumption schedule is needed, on the basis of the information of the date of the food (305).

Here, the determining of whether the generating of the consumption schedule is needed represents determining whether there is any food, for example, perishable food, needing to be consumed within a predetermined period of time from the present point of time.

The food to be consumed includes food that has a predetermined storage period approached, food corresponding to the optimal time of consumption, or food that has the expiration date approached.

In addition, the refrigerator may be able to receive a command to generate a consumption schedule through the user interface unit. At this time, based on whether a command of a user is input, the determining of the generating of the consumption schedule may be possible.

The refrigerator, when the storing of the information with respect to the food is complete and the generating of the consumption schedule is determined not to be needed, resets the target temperature of the storage compartments on the basis of the storage temperature of the purchased food (306).

In addition, the refrigerator determines that food is withdrawn if a food selection command or a food delete command is input (307), and deletes the selected food from the information of the food stored in the storage unit. That is, the information of the food stored in the storage unit is updated (308).

Meanwhile, the refrigerator generates a consumption schedule if determined that the consumption schedule is needed to be generated (309).

Here, the generating of the consumption schedule includes generating a consumption schedule on the basis of the storage status of the food detected by the detection unit 160, identifying at least one of information of the date among from the storage period, the expiration date, and the optimal time of consumption of the food stored at the storage unit, and then generating a consumption schedule on the basis of the identified information of the date of food, generating a consumption schedule on the basis of received weather information when the weather information is received from the weather server, and generating a consumption schedule on the basis of event information.

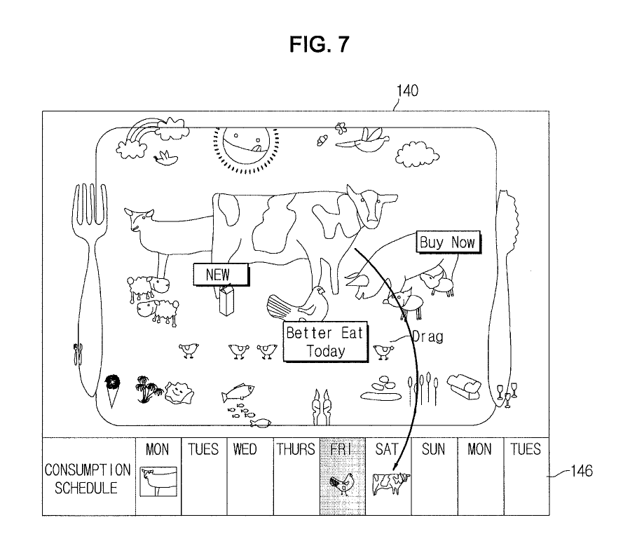

As illustrated on FIG. 7, the user interface unit of the refrigerator displays the consumption schedule 146 on a different domain from the domain on which the information of food is displayed.

In addition, at the time of displaying the consumption schedule, the displaying of a period of time from the present to a predetermined point in time in the future may be possible, and the displaying of a period of time from the present to the point in time in the future and the past may be possible.

In addition, the refrigerator, if a certain food is selected by a user and is dragged to a certain day, adds the selected food as food that needs to be consumed on the day. In this manner, the user directly generates a consumption schedule.

The refrigerator generates a cooking list on the basis of the food within the consumption schedule if the cooking list is selected by a user (310).

Here, the generating of the cooking list includes generating a cooking list on the basis of information of each food that is available to be cooked, the information stored in the storage unit.

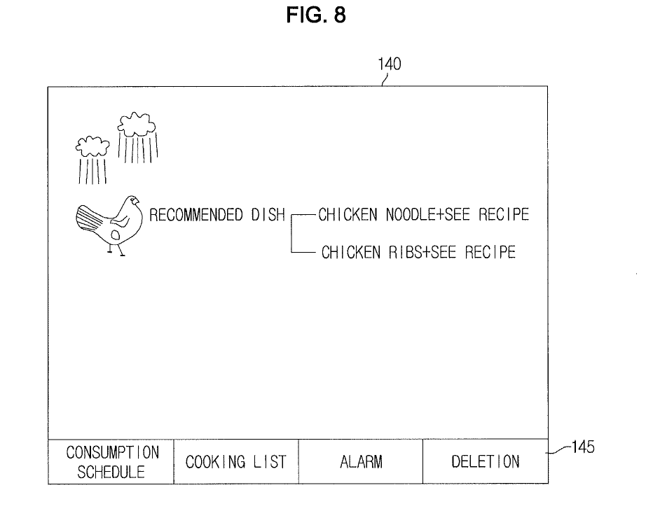

As illustrated on FIG. 8, for example, when recommended dish for today is chicken, and rain is expected, chicken noodle or chicken ribs is displayed as the recommended cooking list, and a recipe to prepare the chicken noodle or chicken ribs is additionally displayed. In addition, the refrigerator may be able to display the recipe or the cooking list not in the form of a text but in the form of a still image or a moving image.

At this time, when a certain one dish is selected by a user, based on the information of the food stored at the storage unit 153, the information of the food that is additionally to be purchased is identified, and the identified information of the food is displayed as a representative image. At this time, a text “Buy Now,” a purchase indicating icon is displayed on the representative image in an overlapping manner.

In addition, the refrigerator may be able to identify a recipe, which is a method of preparing a selected dish, when a certain one dish from a cooking list is selected, and display the identified recipe automatically (311).

By referring to FIG. 7, by identifying the position of the text “Buy Now,”, which is referred to as a purchase indication icon, on the user interface unit, and the representative image at the position, a user may be able to understand that pork meat is needed to be purchased.

In addition, the refrigerator may be able to generate a cooking list on the basis of the received weather information and the consumption schedule when the weather information is received from the weather server.

In addition, a text “Better Eat Today,” referred to as a recommendation icon for today may be displayed on a representative image of food, which is preferred to be consumed today, in an overlapping manner.

In addition, the refrigerator, when information with respect to a new product is received from the food server, displays a representative image of the received new product, and displays a text “New,” referred to as a new product indication icon, on the representative image in an overlapping manner.

By referring to FIG. 7, a user, by identifying the position of the text “New,” on the user interface unit, and the representative image at the position, may be able to understand that a new milk product is introduced or on the shelf of a store.

The refrigerator displays an alarm when the alarm is selected, or automatically displays an alarm window at a certain interval.

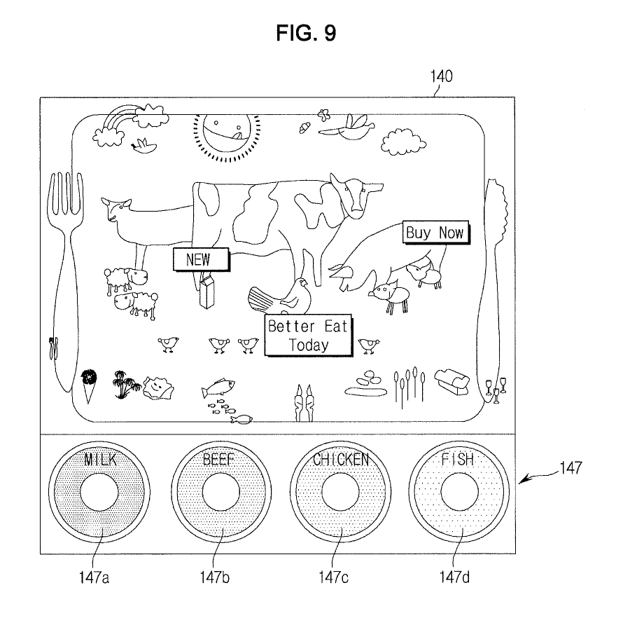

As illustrated on FIG. 9, the refrigerator determines food that is needed to be consumed in the near future on the basis of the storage status, the expiration date, and the storage period of the food, determines the priority on the consumption of the determined food, and displays the priority of consumption in stages such that respective pieces of food information are displayed on alarm windows (147: 147a, 147b, 147c and 147d) having different colors according to the priority of consumption.

Here, the alarm window 147 includes the plurality of alarm windows 147a, 147b, 147c, and 147d having different colors according to the priority of consumption.

That is, when assumed that among food needed to be disposed in a near future, food having the highest priority of consumption is milk, next is beef, followed by chicken, and the food having the least highest priority of consumption is fish, the milk having the highest possibility of decomposition and thus is needed to be consumed first is displayed on a first alarm window 147a in an overlapping manner, the beef is displayed on a second alarm window 147b in an overlapping manner, the chicken is displayed on a third alarm window 147c in an overlapping manner, and the fish having the lowest possibility of decomposition and thus is needed to be disposed last is displayed on a fourth alarm window 147d in an overlapping manner.

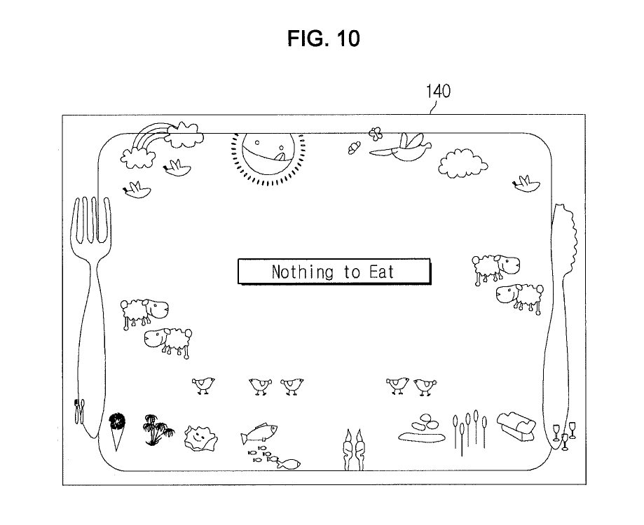

As illustrated on FIG. 10, the refrigerator determines whether any food is present for a user to consume on the basis of the information of the food stored in the storage unit 153, and when determined that no food is present for the user to consume, displays a text “Nothing to Eat” indicating that no food is present.

Although a few embodiments of the present disclosure have been shown and described, it would be appreciated by those skilled in the art that changes may be made in these embodiments without departing from the principles and spirit of the disclosure, the scope of which is defined in the claims and their equivalents.

What is claimed is:

1. A refrigerator comprising:
a communication unit to receive a list of food purchased by a user from a food server;
a control unit to read information with respect to food on the received list of food, and identify a representative image that represents the food based on the read information;
a display unit to display the received list of food such that the food on the list of food is displayed as the representative image that represents the food; and
a storage unit to store the read information.

2. The refrigerator of claim 1, wherein:
the display unit displays additional information of the food on the representative image in an overlapping manner.

3. The refrigerator of claim 1, wherein:
the additional information includes at least one of a period of storage, a storage temperature, a storage place, an expiration date, and an optimal time of consumption.

4. The refrigerator of claim 3, wherein:
the control unit identifies an expiration date of food that is stored in the storage unit, and generates a consumption schedule based on the identified expiration date of the food; and
the display unit displays the generated consumption schedule.

5. The refrigerator of claim 3, further comprising a detection unit to detect a storage status of food stored in a storage compartment,
wherein the control unit generates the consumption schedule based on at least one of the expiration date, the optimal time of consumption, and the storage status of the stored food, and the display unit displays the generated consumption schedule.

6. The refrigerator of claim 5, wherein:
the display unit includes a plurality of alarm windows each having different color information to notify a priority of the consumption in stages, and
the information with respect to the food is displayed on the plurality of alarm windows in an overlapped manner, based on the priority of the consumption.

7. The refrigerator of claim 5, wherein:
the control unit generates the consumption schedule based on the storage status of the food, and
the display unit displays the generated consumption schedule.

8. The refrigerator of claim 1, further comprising:
a detection unit to detect a storage status of food stored in the storage compartment,
wherein the control unit generates the consumption schedule based on the storage status of the stored food, and
the display unit displays the generated consumption schedule.

9. The refrigerator of claim 8, wherein:
the communication unit receives weather information from a weather server, and
the control unit suggests a cooking list based on the received weather information and the consumption schedule.

10. The refrigerator of claim 1, wherein:
the communication unit receives information with respect to a new product from the food server,
the control unit identifies a representative image that represents the received information with respect to the new product, and identifies an icon that corresponds to the new product, and
the display unit displays the identified icon of the new product on the identified representative image of the new product in an overlapping manner.

11. The refrigerator of claim 1, further comprising
an input unit to receive the information with respect to the food purchased by the user, and enable at least one food to be selected on the received list of food.

12. The refrigerator of claim 11, wherein:
the input unit receives a command to delete information with respect to withdrawn food, and
the storage unit deletes the information with respect to the food, which is commanded to be deleted, in the stored information of the food.

13. The refrigerator of claim 1, wherein:
the control unit identifies food that is needed, identifies a representative image of the needed food, and identifies a purchase indication icon indicating that there is a food needed, and
the display unit displays the purchase indication icon on the identified representative image of the needed food in an overlapping manner.

14. A refrigerator, comprising:
a communication unit to receive a list of food purchased by a user by communicating with a food server;
a control unit to read information with respect to food on the received list of food, and generate a consumption schedule based on information of date of the read information with respect to food;
a user interface unit to display the received list of food, and display the generated consumption schedule; and
a storage unit to store the read information with respect to food and the consumption schedule.

15. The refrigerator of claim 14, wherein:
the user interface unit displays the list of food and the consumption schedule on different domains, respectively.

16. The refrigerator of claim 15, wherein:
the user interface unit, when the information with respect to of the food on the list of food is dragged onto the consumption schedule, additionally displays the information with respect to the food on the consumption schedule.

17. The refrigerator of claim 14, wherein:
the information of the date of the food includes at least one of a storage period, an expiration date, and an optimal time of consumption.

18. The refrigerator of claim 14, further comprising:
a detection unit to detect a storage status of food stored in a storage compartment,
wherein the control unit generates the consumption schedule based on the storage status.

19. The refrigerator of claim 18, wherein:
the control unit generates a cooking list based on the generated consumption schedule, and the user interface unit displays the cooking list.

20. The refrigerator of claim 19, wherein:
the control unit identifies a recipe for at least one dish on the cooking list, and
the user interface unit displays the recipe when a command to identify the recipe for the at least one dish.

21. The refrigerator of claim 19, wherein:
the control unit identifies food that is needed, based on the recipe, and
the user interface unit is to display the identified food when the recipe is selected.

22. The refrigerator of claim 17, wherein:
the communication unit receives weather information from the weather server, and
the control unit generates the consumption schedule based on the received weather information.

23. The refrigerator of claim 14, wherein:
the communication unit receives information with respect to a new product, and
the user interface unit displays the information with respect to the new product when the new product is selected.

24. A method of controlling a refrigerator, the method comprising:
receiving information with respect to food purchased by a user;
generating a list of food based on the received information;
reading and storing information with respect to food on the list of food;
identifying a representative image that represents the read information based on the read information;
displaying the food on the list of food as the representative image; and
storing the read information with respect to the food.

25. The method of claim 24, wherein:
the receiving of the information with respect to the food purchased by the user includes:
receiving a list of food purchased by the user, by communicating with at least one of a food server and a mobile terminal.

26. The method of claim 25, wherein:
the receiving of the information with respect to the food purchased by the user includes receiving the information with respect to the food purchased by the user, through a user interface unit.

27. The method of claim 25, further comprising:
displaying at least one of a storage period, a storage temperature, a storage space, an expiration date, and an optimal time of consumption on the representative image in an overlapping manner as additional information.

28. The method of claim 24, further comprising:
identifying at least one information of date of food among a storage period, an expiration date, and an optimal time of consumption of food that are stored in a storage unit;
generating a consumption schedule based on the identified information of date of food; and
displaying the generated consumption schedule.

29. The method of claim 28, wherein the generating of the consumption schedule includes:
detecting a storage status of food stored in a storage compartment; and
generating the consumption schedule based on the storage status.

30. The method of claim 29, further comprising:
receiving weather information from a weather server;
generating a cooking list based on the received weather information and the consumption schedule; and
displaying an identified cooking list.

31. The method of claim 30, further comprising:
identifying a recipe with respect to at least one dish from the cooking list; and
displaying the recipe when a command to identify the recipe is input.

32. The method of claim 24, further comprising:
receiving information with respect to a new product from a food server;
identifying a representative image that represents the received information of the new product;
identifying an icon that indicates the new product; and
displaying the identified icon on the identified representative image in an overlapping manner.

33. The method of claim 24, further comprising:
receiving a command to delete information with respect to food that is withdrawn; and
deleting, by the storage unit, the information of the food that is commanded to be deleted among the information of the food that is stored in the storage unit.

34. The method of claim 24, further comprising:
identifying food that is needed;
identifying a representative image with respect to the food that is identified as needed;
identifying a purchase indication icon indicating there is a food that is needed; and
displaying the identified purchase indication icon on the identified representative image in an overlapping manner.
